(19) United States
(12) Patent Application Publication
(10) Pub. No.: US 2016/0107708 A1
(43) Pub. Date: Apr. 21, 2016

(54) SHOCK ABSORPTION PIN BOX

(71) Applicant: LIPPERT COMPONENTS, INC., Elkhart, IN (US)

(72) Inventors: Michael J. FIWEK, Plymouth, IN (US); Jeffrey K. ALBRECHT, Goshen, IN (US); Christopher S. GREER, Syracuse, IN (US)

(21) Appl. No.: 14/919,341

(22) Filed: Oct. 21, 2015

Related U.S. Application Data
(60) Provisional application No. 62/066,637, filed on Oct. 21, 2014.

(51) Int. Cl. B62D 53/08

(52) U.S. Cl. CPC B62D 53/0807

(57) ABSTRACT

A pin box includes a frame, a swing arm pivotally connected to the frame, and a pivot plate pivotally connected to the swing arm. An air spring disposed between the frame and swing arm may be selectively compressed and decompressed. A dampener connected between the swing arm and the frame dampens movement of the swing arm with respect to the frame. A rubber spring disposed between the pivot plate and the swing arm is selectively compressible there between when the pivot plate pivots with respect to the swing arm.

### CROSS REFERENCE TO RELATED APPLICATION

This application claims benefit of U.S. Provisional Patent Application No. 62/066,637, filed on Oct. 21, 2014, and incorporates by reference the disclosure thereof in its entirety.

### BACKGROUND AND SUMMARY OF THE DISCLOSURE

The present disclosure relates generally to a pin box for coupling a fifth-wheel trailer to a fifth-wheel hitch on a tow vehicle. More particularly, it relates to a pin box configured to absorb and/or dampen shocks that might be transmitted between a trailer and a tow vehicle. Such shocks might occur when the tow vehicle accelerates and decelerates with a trailer under tow.

The pin box includes a frame, a swing arm pivotally connected to the frame, and a pivot plate pivotally connected to the swing arm. An air spring is disposed between the frame and the swing arm in compressible engagement therewith such that the air spring biases the frame and spring arm away from each other. A dampener is connected at a first end to the swing arm and at a second end to the frame. A rubber spring is disposed between the swing arm and the pivot plate such that at least portions thereof are selectively compressible by the swing arm and pivot plate when the pivot plate pivots with respect to the swing arm.

### BRIEF DESCRIPTION OF THE DRAWINGS

FIG. 1 is a perspective view of an illustrative shock absorption pin box according to the present disclosure;

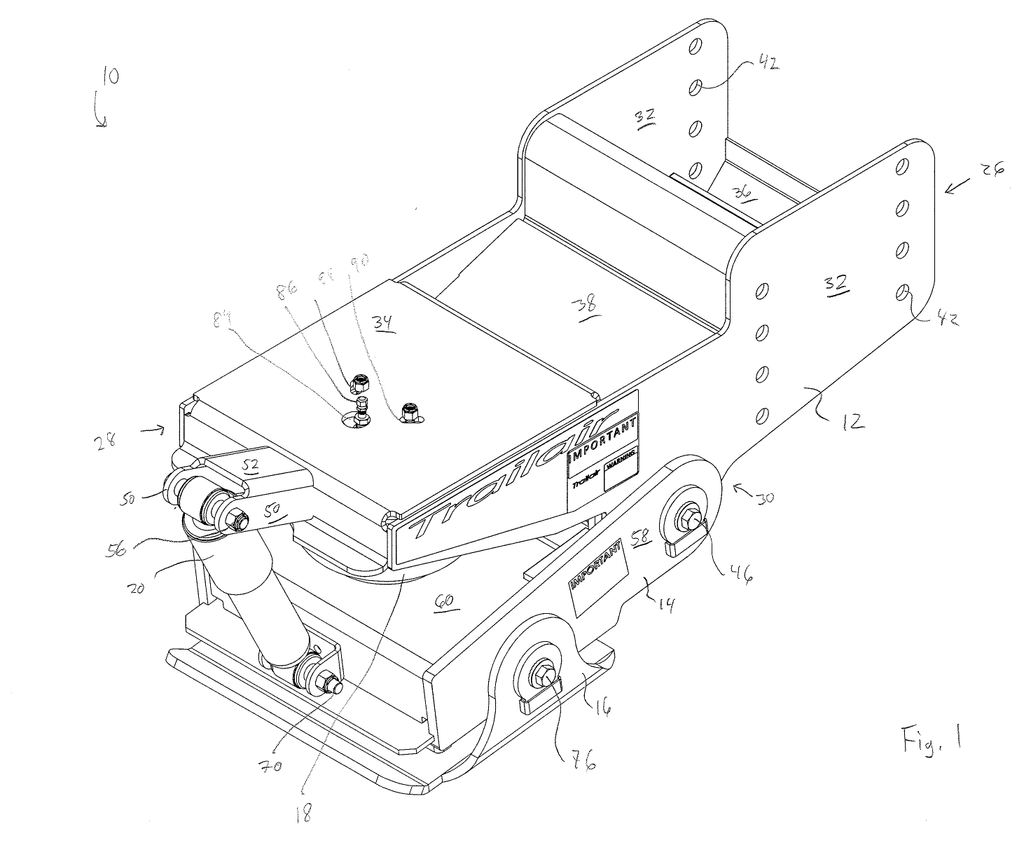

FIG. 2 is a side elevation view of the pin box of FIG. 1;

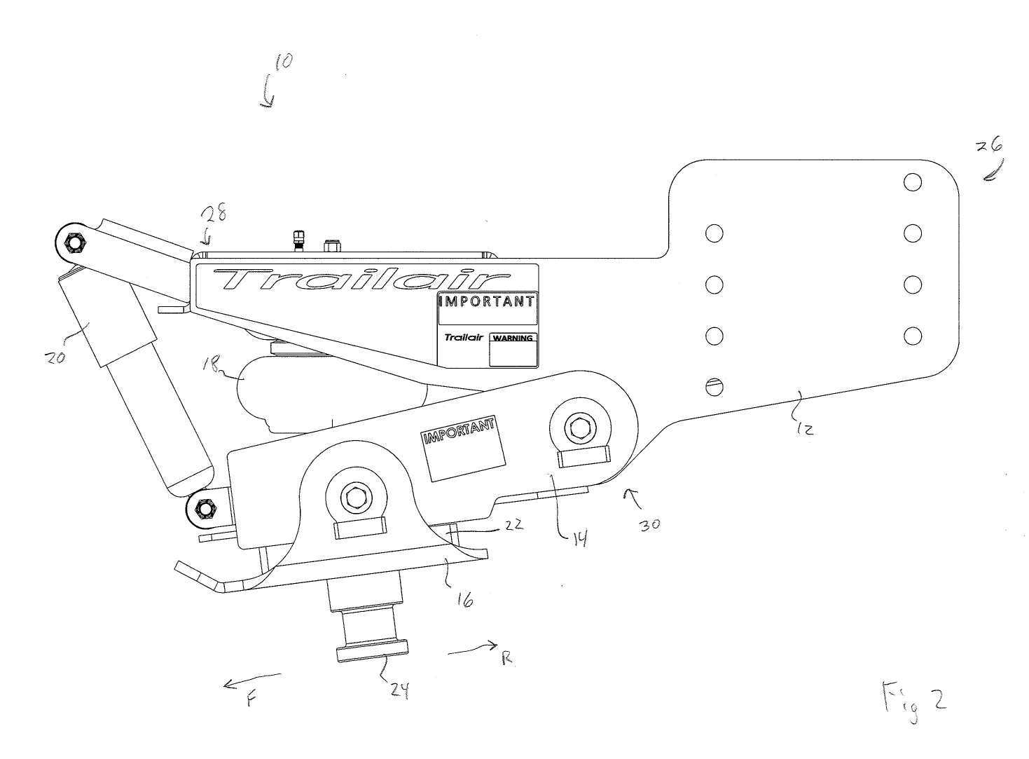

FIG. 3 is a top plan view of the pin box of FIG. 1;

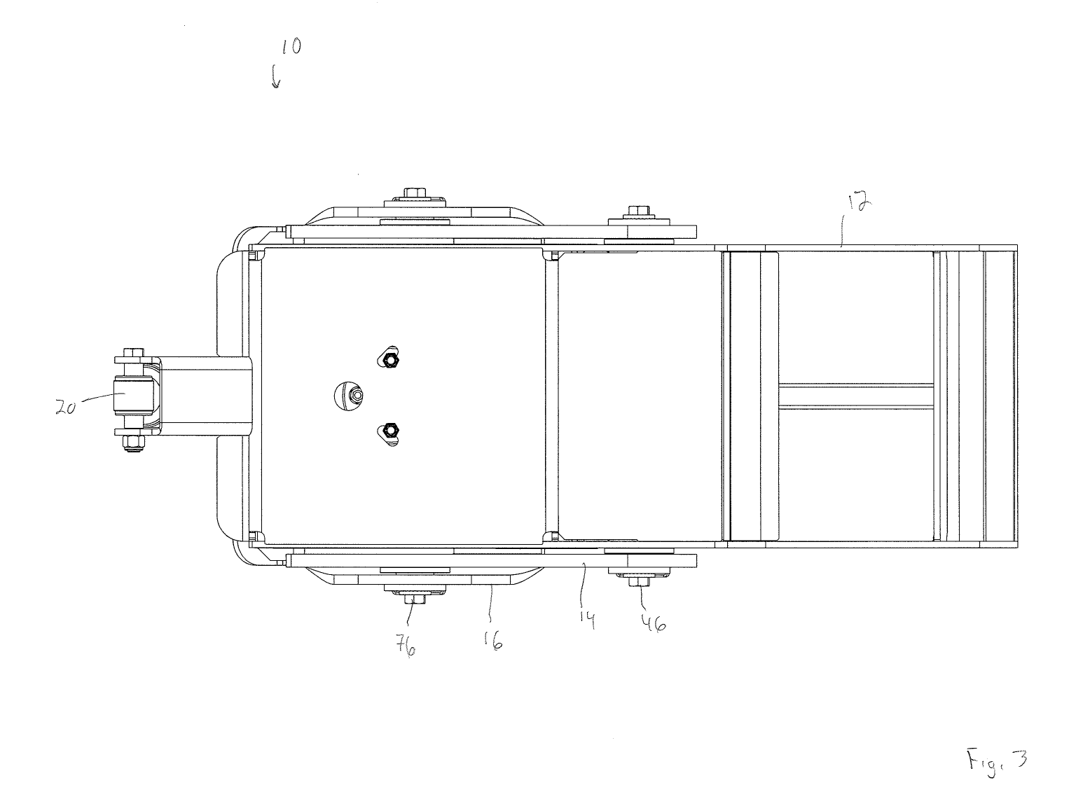

FIG. 4 is a bottom plan view of the pin box of FIG. 1;

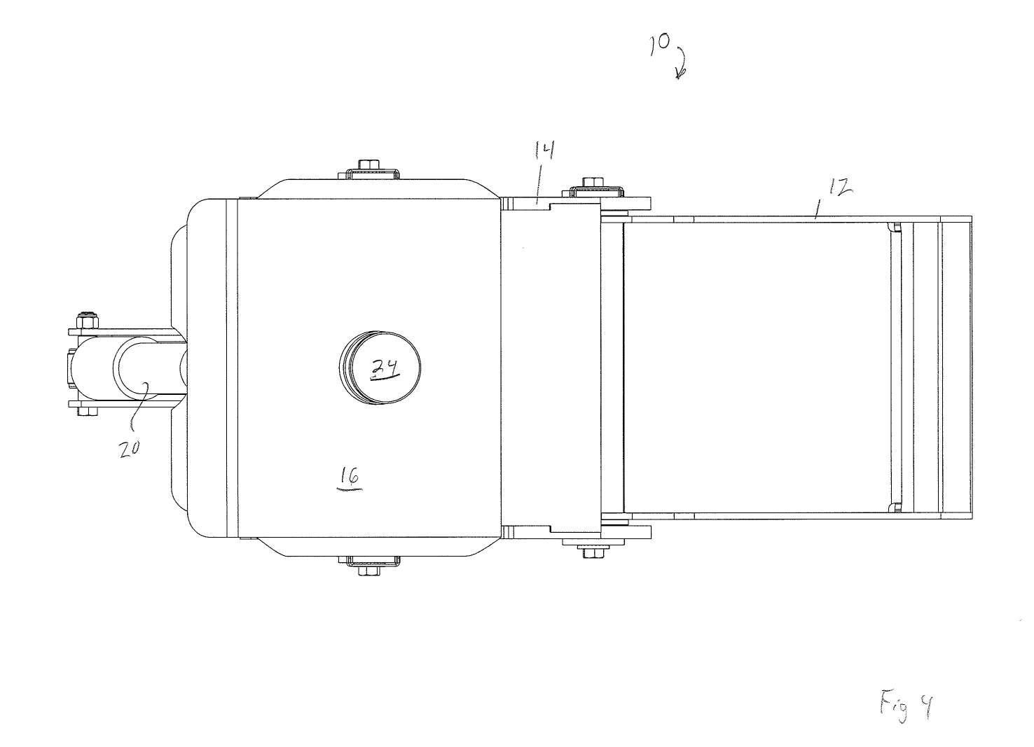

FIG. 5 is a front elevation view of the pin box of FIG. 1; and

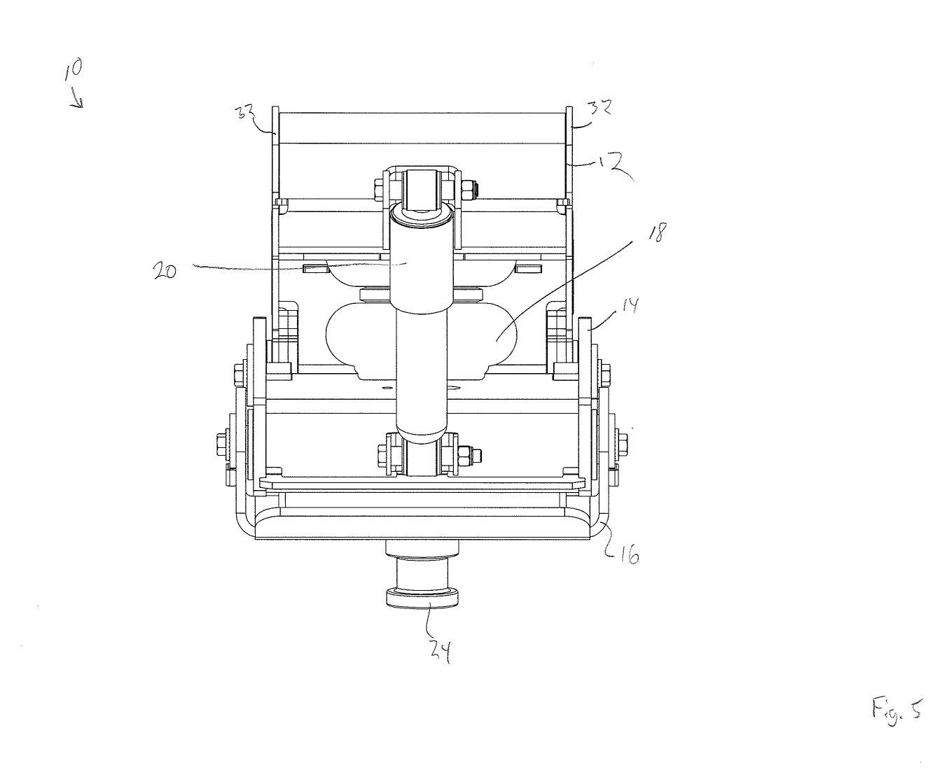

FIG. 6 is an exploded perspective view of the pin box of FIG. 1.

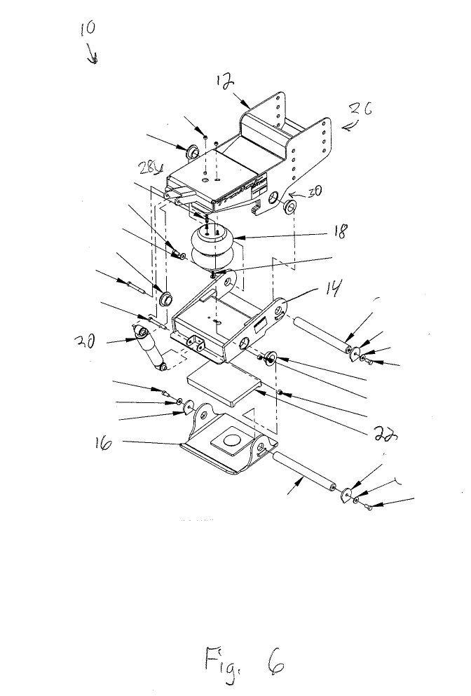

### DETAILED DESCRIPTION OF THE DRAWINGS

The drawings show an illustrative shock absorption pin box 10. The pin box 10 includes a frame 12, a swing arm 14 pivotally connected to the frame 12, and a pivot plate 16 pivotally connected to the swing arm 14. An air spring 18 is disposed between the frame 12 and swing arm 14 and is configured to resist pivoting of the swing arm toward the frame 12. The air spring 18 may also be configured to resist pivoting of the swing arm 14 away from the frame 12. A dampener 20 is pivotally connected at a first end to the frame 12 and at a second end to the swing arm 14. A rubber spring 22 is disposed on the swing arm 14 and in engagement or selective engagement with the pivot plate 16. Alternatively, the rubber spring 22 may be disposed on the pivot plate 16 and in engagement or selective engagement with the swing arm 14. A kingpin 24 extends from the pivot plate away from the frame 12.

The frame 12 has a first end 26, a second end 28, and a lower intermediate portion 30 between the first end and the second end. The first end 26 of the frame 12 is configured for attachment to a trailer frame (not shown), for example, by welding or using mechanical fasteners. The illustrative frame 12 includes first and second frame side plates 32, a frame top plate 34, a frame rear plate 36, a frame intermediate plate 38, and a frame bottom plate 40. Each of the frame top plate 34, frame rear plate 36, frame intermediate plate 38, and frame bottom plate 40 spans and is attached to the frame side plates 32. Apertures 40 may be provided in the frame side plates 32 to facilitate attachment of the frame 12 to the trailer frame. Apertures 44 proximate a lower intermediate portion of the frame side plates 24 are configured to receive a pin 46 pivotally connecting the swing arm 14 to the frame 12. A frame bracket 48 configured to receive an upper end of the dampener 20 extends in a forward and upward direction from a forward portion of the frame 12. The bracket 48 includes a pair of bracket side plates 50 and a stiffener 52 connected to the bracket side plates 50 and a forward portion of the frame top plate 34. The bracket side plates 50 include apertures 54 configured to receive a pin 56 pivotally connecting an upper end of the dampener 20 to the frame 12. The frame top plate 34 includes an aperture 84 configured to receive a fill and vent port 86 of the air spring 18. The frame top plate 34 also includes one or more apertures 88 configured for receiving one or more securing studs 90 for securing the air spring 18 to the frame top plate.

The swing arm 14 includes a pair of swing arm side plates 58, a swing arm upper plate 60, and a swing arm lower plate 62. The swing arm upper plate 60 and swing arm lower plate 62 span and are attached to the swing arm side plates 58. The swing arm side plates include apertures 72 for receiving the pin 46 pivotally connecting the swing arm 14 to the frame 12. The swing arm side plates also include apertures 74 for receiving a pin 76 pivotally connecting the swing arm 14 to the pivot plate 16. A U-shaped swing arm bracket 64 is connected to a forward-facing portion of the swing arm upper plate 60. The swing arm bracket 64 includes a pair of bracket flanges 66 configured to receive a lower end of the dampener 20. The bracket flanges 66 include apertures 68 configured to receive a pin 70 pivotally connecting a lower end of the dampener 20 to the swing arm 14. The swing arm upper plate 60 includes one or more apertures 94 for receiving one or more securing studs 90 for securing the air spring 18 to the swing arm upper plate 60.

The pivot plate 16 includes a web 78 and a pair of pivot plate flanges 80 extending upwardly from the web 78. An ear 92 extends forwardly and upwardly from web 78. The pivot plate flanges 80 include apertures 82 configured to receive the pin 76 pivotally connecting the pivot plate 16 to the swing arm 14.

The spring characteristics of the air spring 18 may be adjusted by adding or removing air therefrom via the fill and vent port 86. In an embodiment, another form of spring, for example, a helical compression spring, could be substituted for the air spring 18.

The dampener 20 may be a telescopic dampener pivotally connected between the frame 12 and the swing arm 14 and configured to dampen oscillations of the swing arm with respect to the frame.

The rubber spring 22 may be bonded or otherwise attached, for example, using mechanical fasteners, to one of the pivot plate 16 and the swing arm lower plate 62. The rubber spring 22 is configured to be compressed between the swing arm lower plate 62 and the pivot plate 16 as the pivot plate pivots with respect to the swing arm lower plate 62. The rubber spring 22 is shown as a generally rectangular and flat member but could have other forms. In an embodiment, another form of spring, for example, an air spring could be substituted for the rubber spring 22.

In use, the first or rear end 26 of the pin box 10 is attached to the frame of a trailer (not shown), and the king pin 24 is connected to a fifth wheel hitch (not shown) of a tow vehicle (not shown). With the tow vehicle and trailer initially at rest, the air spring 18 and rubber spring 22 will gravitate toward an equilibrium state wherein the air spring is in a first state of compression and the rubber spring is uncompressed or substantially evenly compressed from front to rear. When the tow vehicle accelerates forward, the fifth wheel hitch imparts a forward force F on the king pin 24, causing the pivot plate 16 to pivot forward about the pin 76. This forward pivoting of the pivot plate 16 causes the forward portion of the rubber spring 22 to be compressed between the pivot plate and the swing arm lower plate 62. The forward force F may also cause the swing arm to pivot about pin 46, thereby compressing the air spring 18 and the dampener 20. When the tow vehicle decelerates, the forward momentum of the trailer imparts a rearward force R on the king pin 24, causing the pivot plate 16 to pivot rearward about the pin 76. This rearward pivoting of the pivot plate 16 causes the forward portion of the rubber spring 22 to become uncompressed and the rearward portion of the rubber spring to become compressed between the pivot plate and the swing arm lower plate 62. The rearward force R may also cause the swing arm to pivot about pin 46, thereby decompressing the air spring 18 and the dampener 20. With the tow vehicle traveling at a substantially constant speed, the swing arm 14 and pivot plate tend to and/or oscillate through the equilibrium state. The dampener 20 dampens such oscillations.

The rubber spring 22, air spring 16, and/or dampener 20 also may absorb and dampen shock resulting from rough road conditions in a similar manner.

The foregoing disclosure is illustrative and the details thereof could be modified without departure from the scope of the appended claims.

1. A pin box comprising:
a frame having a first end a second end and an intermediate portion;
a swing arm having a first end and a second end, said swing arm pivotally connected to said frame;
a dampener connected between said frame and said swing arm;
a pivot plate pivotally connected to said swing arm;
an air spring disposed between said frame and said swing arm; and
a rubber spring disposed between said pivot plate and said swing arm.

2. The pin box of claim 1 wherein said first end of said frame comprises first and second frame side plates and a frame bottom plate joined to said first and second frame side plates.

3. The pin box of claim 2 wherein said air spring is connected to said frame bottom plate.

4. The pin box of claim 3 wherein said swing arm comprises first and second swing arm side plates and a swing arm upper plate.

5. The pin box of claim 4 wherein said air spring further is connected to said swing arm upper plate.

6. The pin box arm of claim 5 wherein said pivot plate is pivotally connected said first and second swing arm side plates.

7. The pin box of claim 6 wherein said swing arm further comprises a swing arm bottom plate.

8. The pin box of claim 7 wherein said rubber spring is selectively compressible between said pivot plate and said swing arm bottom plate in response to pivoting of said pivot plate with respect to said swing arm.

9. The pin box of claim 8 further comprising a king pin extending from said pivot plate.

10. A pin box comprising:
a frame having a first end a second end and a lower intermediate portion;
a swing arm having a first end and a second end, said first end of said swing arm pivotally connected to said lower intermediate portion of said frame;
a dampener connected between said second end of said frame and said second end of said swing arm;
a pivot plate pivotally connected to said swing arm;
an air spring disposed between said frame and said swing arm;
a rubber spring disposed between said pivot plate and said swing arm; and
a king pin extending from said pivot plate.

11. The pin box of claim 10 wherein said frame comprises first and second frame side plates.

12. The pin box of claim 11 wherein said swing arm is pivotally connected to said first and second frame side plates.

13. The pin box of claim 12 wherein said air spring is configured to bias said swing arm away from said frame.

14. The pin box of claim 13 wherein said dampener is configured to dampen oscillation of said swing arm with respect to said frame.

15. The pin box of claim 14 wherein said rubber spring is configured for selective compression between said pivot plate and said swing arm in response to pivoting of said pivot plate with respect to said swing arm.

16. A pin box comprising:
a frame having a first end a second end and an intermediate portion;
a swing arm having a first end and a second end, said swing arm pivotally connected to said frame;
a pivot plate pivotally connected to said swing arm;
a first spring disposed between said frame and said swing arm; and
a second spring disposed between said pivot plate and said swing arm.

17. The pin box of claim 16 further comprising a dampener connected between said frame and said swing arm.

18. The pin box of claim 16 wherein said first spring is configured bias said swing arm away from said frame.

19. The pin box of claim 18 wherein said first spring is an air spring.

20. The pin box of claim 18 wherein said second spring is configured for selective compression between said pivot plate and said swing arm in response to pivoting of said pivot plate with respect to said swing arm.
